(19) United States
(12) Patent Application Publication
(10) Pub. No.: US 2012/0280459 A1
(43) Pub. Date: Nov. 8, 2012

(54) STAINFREE PLUMBER'S PUTTY

(75) Inventors: Amrit Parhar, Westlake, OH (US); Raymond Toby Rael, Council Bluffs, IA (US); Hayat El-Khoury, Middleburg Heights, OH (US)

(73) Assignee: OATEY CO., Cleveland, OH (US)

(21) Appl. No.: 13/464,078

(22) Filed: May 4, 2012

Related U.S. Application Data
(60) Provisional application No. 61/483,227, filed on May 6, 2011.

(51) Int. Cl. F16J 15/14

(52) U.S. Cl. 277/627

(57) ABSTRACT

A stainfree plumber's putty comprises at least one particulate filler and an organic binder comprising a liquid polyester and a low density wax, the putty being formulated to pass ASTM-D-2203—Staining of Oil and Resin-Base Caulking Compounds.

### CROSS-REFERENCE TO RELATED APPLICATION

This application claims the benefit of U.S. Provisional Patent Application Ser. No. 61/483,227, entitled “STAINFREE PLUMBER'S PUTTY” and filed May 6, 2011, the entire disclosure of which is incorporated herein by reference.

### BACKGROUND

U.S. Pat. No. 7,434,812 to Wrobleski et al., the entire disclosure of which is incorporated herein by reference, describes a stainfree plumber's putty which is said to be capable of sealing marble and other porous surfaces without producing a noticeable stain. In practice, however, it has been found that noticeable stains are still produced when this product is used on at least some surfaces. In addition, manufacture of this product can be difficult due to its rubbery component, which is an essential ingredient.

### SUMMARY

In accordance with this invention, it has been found that a truly stainfree plumber's putty can be easily made by eliminating the low molecular weight hydrocarbon solvent optionally present in the Wrobleski et al. putty, provided that the organic binder of the inventive putty is formulated from the combination of a liquid polyester and a low density wax. In particular, it has been found that a plumber's putty formulated in this way will not only be truly stainfree, but also exhibit the elasticity and shape retention (slumpfree) properties necessary for an effective plumber's putty, even though the rubbery ingredient essential of the Wrobleski et al. product putty has been totally eliminated.

Thus, this invention provides an elastic, stainfree, slumpfree plumber's putty comprising at least one inorganic particulate filler and an organic binder comprising a liquid polyester and a low density wax.

### DETAILED DESCRIPTION

### Liquid Plasticizer

The organic binder of the inventive stainfree plumbers putty comprises a liquid plasticizer and a low density wax.

Compounds which are capable of functioning as plasticizers for natural and synthetic elastomers are well known and described, for example, in The HallStar Company's product brochure entitled “Plasticizer/Polymer Polarity Chart” available on the web at http://www.hallstar.com/tech does, the disclosure of which is incorporated herein by reference. Any of these plasticizers can be used, provided that they are liquid at room temperature.

Preferred liquid plasticizers for use in this invention are polymeric polyesters having average molecular weight of 2,000-10,000, more typically 3,000-8,000, or even 4,000-6,000, and viscosities ranging from about 1500 to 7500 Cst., preferably about 3300-5500 Cst, at 80° C.

Examples of preferred liquid polyesters include polymers based on adipic acid and other saturated dibasic acids having the general formula, HOOC(CH₂)ₙCOOH, where n=2-20, preferably n=6-10, ethylenically unsaturated polybasic acids such as maleic acid, itaconic acid, etc., and aromatic unsaturated polybasic acids such as isophthalic acid, terephthalic acid, trimellitic acid, 1,3,5-phenyltricarboxylic acid, etc. Especially preferred are the polyesters based on saturated dibasic acids having the general formula, HOOC(CH₂)ₙCOOH, where n=2-20, e.g., glutarates, adipates, azelates, and sebacates, preferably n=6-10. Commercial examples of these include the Paraplex series offered by CP Hall, such as Paraplex G-40 which is a polymeric adipate polyester plasticizer having an average molecular weight of about 6000 and a viscosity of about 4100 Cst. @80 C, Paraplex G-59 which is a polymeric adipate polyester plasticizer having an average molecular weight of about 3500 and a viscosity of about 60 Cst. @ 25° C., Paraplex G-54 which is a polymeric adipate polyester plasticizer having an average molecular weight of about 2100 and a viscosity of about 45 Cst. @ 25° C., and Paraplex A 8600 which is a mixture of polymeric adipates having an average molecular weight of about 2700 but a viscosity of 30,500 Cst. @ 25° C.

The amount of liquid plasticizer included in the inventive plumber's putty can vary widely and essentially any amount can be used. Generally speaking, the amount of liquid plasticizer included in the inventive plumber's putty will be about 5 to 40 wt. %, more typically about 10 to 25 wt. % or even 15 to 19 wt. %, based on the weight of the entire plumber's putty as a whole. In terms of the organic binder of the inventive plumber's putty, this means that the amount of liquid polyester included in the inventive plumber's putty will be about 30 to 80 wt. %, more typically about 45 to 75 wt. % or even 50 to 70 wt. %, based on the weight of the organic binder of the inventive plumber's putty.

### Low Density Wax

The second component of the organic binder of the inventive stainfree plumbers putty is a low density wax. Normally, this ingredient will be a synthetic wax made by polymerizing or copolymerizing ethylene and/or its closely related homologues propylene, n-butylene and iso-butylene to form a polymerized product having a density of about 0.5 to 1.2 Wee, preferably 0.75 to 0.95 Wee. Preferred low density synthetic waxes also have Drop melt points of 120 to 250° F. (48.9 to 121.1° C.), preferably 180 to 200° F. (82.2 to 93.3° C.). Oxidized versions of these synthetic waxes, e.g., oxidized polyethylene was, can be also be used.

Specific examples of low density synthetic waxes that can be used for this purpose include Low density Polyethylene wax from Marcus Oil and Chemical Company of Houston, Tex. and Vestowax A118 from Evonik Degussa Corp, of Parsippany, N.J., micronized wax, etc.

Another type of low density wax that can be used in the inventive plumber's putty can be described as a high molecular weight polymer based on isobutylene that has a typical molecular weight range of 40,000 to 150,000, preferably 50,000 to 110,000, most preferably, about 70,000. An example of this polymer is Vista LM-MS supplied by Exxon Chemicals. Vistanex polyisobutylene polymers are highly paraffinic hydrocarbon polymers. They are highly inert, tasteless and non-toxic.

This low density wax component also acts as an adhesion promoter, helping to bind the other components of the inventive plumber's putty to each other as well as to the surfaces of the objects to be bonded. Surprisingly, it has been found that the combination of this low density wax plus the liquid polyester mentioned above provides better binding than either component alone. In particular, as illustrated in the working examples below, a binder formulated from a mixture of low density wax and liquid polyester formulated in accordance with this invention is capable of providing better shape retention in the product plumber's putty obtained at lower organic binder concentrations compared with otherwise identical products made with only one or the other of these binder ingredients.

The amount of low density wax included in the inventive plumber's putty can vary widely and essentially any amount can be used. Generally speaking, the amount of low density wax included in the inventive plumber's putty will be about 1 to 35 wt.%, more typically about 3 to 10 wt. % or even 4 to 8 wt. %, based on the weight of the entire plumber's putty as a whole. In terms of the organic binder of the inventive plumber's putty, this means that the amount of low density wax included in the inventive plumber's putty will be about 4 to 60 wt. %, more typically about 10 to 40 wt. % or even 15 to 30 wt. %, based on the weight of the organic binder of the inventive plumber's putty.

### Polyol

In addition to the liquid polyester and low density wax mentioned above, the organic binder of the inventive plumber's putty can optionally contain a non-migrating polyol such ethylene glycol, propylene glycol, 1-4 butanediol, hexylene glycol and the like. In this context, “non-migrating” means liquid at room temperature. In addition to these diols, any other polyol having a molecular weight of no greater than about 200, more typically no greater than about 150 or even 100 can be used. For example, glycerol and other triol and polyols containing three or more hydroxyl groups per molecule can be used.

In accordance with this invention, it has been found that this non-migrating polyol acts as a softening agent without causing the inventive plumber's putty to lose its desirable elasticity, shape retention and stainfree characteristics. That is to say, addition of a small but suitable amount of this ingredient in the inventive plumber's putty produces a product which is softer and more pliable than would otherwise be the case while at the same time allowing the inventive plumber's putty to maintain its desirable, stainfree, elasticity and shape retention characteristics.

Since this ingredient is optional, it can be totally omitted from the inventive plumber's putty if desired. When present, the amount of non-migrating polyol included in the inventive plumber's putty should be enough to cause a noticeable increase in the pliability of the plumber's putty obtained. In general, this means that the amount of non-migrating polyol included in the inventive plumber's putty will be >0 to about 15 wt. %, more typically about 2 to 7 wt. % or even about 3 to 6 wt.%, based on the weight of the entire plumber's putty as a whole. In terms of the organic binder of the inventive plumber's putty, this means that the amount of non-migrating polyol included in the inventive plumber's putty will be >0 to about 40 wt. %, more typically about 5 to 30 wt. % or even about 10 to 25 wt. %, based on the weight of the organic binder of the inventive plumber's putty.

### Particulate Filler

In accordance with this invention, a non-wax particulate filler is included in the inventive stainfree plumber's putty. The basic function of this filler is to act as an extender, thereby adding body and bulk to this product. A secondary function of the filler is that it affects both the hardness and the shape retention properties of the product obtained.

Any non-wax particulate which is capable of providing these functions can be used for this purpose, in theory. In practical terms, only those particulates which are less expensive than the organic binder they replace will be used.

Normally, this means that high density fillers will be used for this purpose, because they usually provide the best performance at the lowest cost. In this context, a “high density filler” will be understood to mean a filler having an average dry bulk density of at least about 1.5 g/cc. Preferred high density fillers have average dry bulk densities of at least about 2.0 g/cc, at least about 2.25 g/cc, or even at least about 2.5 g/cc.

Good examples of materials which can be used as high density fillers include various naturally occurring clays such as Kaolin, bentonite, montmorillonite or modified montmorillonite, attapulgate, Buckminsterfuller's earth, etc., other naturally occurring or naturally derived materials such as mica, calcium carbonate, aluminum carbonate, various silicates such as calcium silicate, aluminum silicate, magnesium silicate, etc., various oxides such as titanium dioxide, calcium oxide, silicon dioxide (e.g., sand), various man-made materials such as precipitated calcium carbonate, precipitated silica, etc., various waste materials such as crushed blast furnace slag, etc., and the like Especially interesting high density fillers include calcium carbonate, Kaolin clays from Unimin Corporation, Dalton, Ga., precipitated silica and mica, as these materials are readily available and inexpensive.

A preferred high density filler is calcium carbonate. Calcium carbonate obtained from natural sources is typically platelet in form and is normally referred to as “ground” calcium carbonate. Calcium carbonated produced synthetically is normally referred to as “precipitated” calcium carbonate. Both types can be used as the high density filler in this invention. For best results, the calcium carbonate used, whether ground or precipitated, will have a particle size of about 2-8 microns, more typically, 3-7 microns or even 4-6 microns in its smallest dimension.

Calcium carbonate is widely used as a filler in plastics. For example, calcium carbonate is used in amounts of up to 70 phr (parts per hundred parts of resin) to improve the tensile strength, elongation and volume resistivity of polyvinyl chloride sheathing for electrical cables. In addition, calcium carbonate is also used to increase the rigidity of polypropylene and as a filler (extender) in ABS (acrylonitrile/butadiene/styrene) thermoplastic resins as well as various thermosetting resins. Calcium carbonate is a preferred high density filler for use in this invention, because it can impart a significant improvement in the mechanical properties of plumber's putties in which it is contained.

In addition to high density fillers, the inventive stainfree plumber's putty can also include low density fillers as well as medium density fillers. In this context, low density fillers will be understood to mean fillers having an average dry bulk density of no more than about 0.6 g/cc. Preferred low density fillers have average dry bulk densities of no more than about 0.4 glee, or even no more than about 0.2 glee. Meanwhile, medium density fillers will be understood to mean fillers having densities of from greater than about 0.6 glee to less than about 1.5 g/cc.

Good examples of useful low density fillers include naturally occurring minerals such as pearlite, vermiculite, etc., manmade materials such as hollow microspheres and microballons made from glass, ceramics or synthetic resins such as phenolic resins, etc., fumed silica, various lightweight waste products such as ground up tires, ground up wood fibers, ground up cellulose fibers, ground up polymer foams made from a variety of different polymers including polyesters, polyamides, polystyrenes, polyurethanes, polyisocyanurates, etc., and so forth. Specific examples of suitable light weight fillers include SilCell hollow glass microspheres having a density of about 0.14 glee available from Silbrico of Hodgkins, Ill.; Q-Cel hollow microspheres generally having dry bulk densities on the order of about 0.10-0.48 glee (about 7-30 lbs/ft.³) available from Potters Industries Inc, Malvern, Pa.; Fillite hollow microspheres available from Omya, UK; and Expancel expandable microspheres available from AKZO NOBEL, Duluth, GA. Additional examples include fumed silica, polystyrene foam and ground up tires having a dry bulk density of about 0.30-0.55 g/cc (about 20-35 lbs/ft.³) such as those available from Lehigh Technologies of Tucker, Ga.

In addition to high density and low density fillers, these compositions can also include medium density fillers, i.e., fillers whose densities approximate that of the organic binder of the inventive plumber's putty. For example, such medium density fillers can have densities of from greater than about 0.6 g/cc to less than about 1.5 glee. Good examples of useful low medium density fillers include various polymer resins such as polyesters, polyamides, polystyrenes, polyurethanes, polyisocyanurates, etc.

The shape of the particulate filler is not critical, and particulates of essentially any shape can used. For example, essentially spherical particles such as silica sand exhibiting an angle of repose of at least about 27 or even at least about 30 can be used. Alternatively, particulate fillers in the form of fibers having length/diameter ratios of up to 1000 or more can be used, although length/diameter ratios of up to about 750, up to about 500, or up to about 250, are more common. Similarly, naturally occurring minerals which are platelet in form can also be used. Indeed, the preferred naturally occurring high density filler, calcium carbonate, is platelet in form. Aspect ratios in such materials of up to about 100 are not uncommon, with aspect ratios of up to about 50, or even up to about 25, being more common.

The particle size of the particulate filler is also not critical, and essentially any particle size can be used so long as the inventive plumber's putty retains the desired degree of flexibility and elasticity, as mentioned above. To this end, the average particle size of the particulate filler in its smallest dimension is preferably about 140 microns, 2-8 microns, more typically, 3-7 microns or even 4-6 microns.

In an especially interesting embodiment of this invention, combinations of two or more high density fillers are used. So, for example, mixtures of a calcium carbonate and clay provide especially interesting properties. For this purpose, any calcium carbonate filler can be used such as synthetically produced precipitated calcium carbonate as well as ground calcium carbonate derived from various different natural sources including minerals such as limestone, chalk, marble, travertine, tufa, and animal sources such plankton, coralline algae, sponges, brachiopods, echinoderms, bryozoa and molluscs. As for the clay, any naturally occurring aluminums silicate composed primarily of fine-grained minerals can be used such as kaolin, bentonite, montmorillonite, modified montmorillonite, attapulgate, Buckminsterfuller's earth, etc. Particularly interesting are combinations of ground calcium carbonate and montmorillonite clays in which the relative portions of montmorillonite clay to calcium carbonate to is about 1:90 to 1:5, more typically 1:60 to 1:20 or even 1:45 to 1:25 on a weight basis.

The amount of particulate filler included in the inventive plumber's putty can vary widely and essentially any amount can be used. Generally speaking, the amount of particulate filler included in the inventive plumber's putty will be about 40-95 wt. %, more typically about 50 to 90 wt. %, 60 or 85 wt. % or even 65 to 80 wt. %, based on the weight of the entire plumber's putty as a whole.

In an especially interesting embodiment of this invention, the inventive stainfree plumber's putty contains >0 to about 10 wt. %, more typically about 0.5 to 5 wt. % or even about 1 to 3 wt. % montmorillonite clay, >0 to about 90 wt. %, more typically about 50 to 85 wt. % or even about 60 to 80 wt. % calcium carbonate, about 5 to 40 wt. %, more typically about 10 to 25 wt. % or even about 15 to 19 wt. % of an adipate polyester plasticizer having an average molecular weight of about 6000 such as Paraplex G-40, about 1 to 35 wt. %, more typically about 3 to 10 wt. % or even about 4 to 8 wt. % low density polyethylene, and >0 to about 15 wt. %, more typically about 2 to 7 wt. % or even about 3 to 6 wt. % propylene glycol.

### Optional and Excluded Ingredients

The inventive stainfree plumber's putty can include various additional ingredients found in conventional plumber's putties, including those indicated to be stainfree such as the Wrobleski et al. plumber's putty mentioned above. For example, the inventive stainfree plumber's putty can include the hydrocarbon solvents (e.g., mineral spirits and Shellflex 2300) mentioned in the Wrobleski et al. patent, the animal and vegetable oils mentioned in the Wrobleski et al. patent which are commonly used in conventional plumber's putties, and the hydrocarbon and other oils of higher molecular weights also mentioned in the Wrobleski et al. patent. The inventive stainfree plumber's putty can also include the rubbery ingredient which is an essential ingredient of Wrobleski et al. plumber's putty.

However, these ingredients are not required in the inventive stainfree plumber's putty and hence are preferably avoided, since they not only are unnecessary but also add additional cost. Moreover, since the hydrocarbon solvents, animal oils and vegetable oils mentioned above can cause staining problems, the amounts of these ingredients included in the inventive plumber's putty, if any, should be kept to a minimum. In particular, the amounts of these ingredients included in the inventive plumber's putty, if any, should be less than that which would cause a staining problem. In other words, the inventive plumber's putty should be essentially free of low molecular weight solvents, oils and other ingredient capable of preventing the inventive plumber's putty from being “stainfree” as that term is further defined below. Preferably, the inventive plumber's putties are entirely free of these ingredients.

### Properties

In addition to being stainfree, the inventive stainfree plumber's putty preferably is also “elastic” and “slumpfree.” In addition, it preferably also exhibits a suitable “feel” and “hardness.”

The staining properties of a plumber's putty can be determined by ASTM-D-2203-Staining of Oil and Resin-Base Caulking Compounds. In accordance with this test, ten sheets of high grade dried filter paper are stapled together and placed on a glass plate. A brass ring of 19 mm inside diameter, 19 mm high and beveled at one end is placed on the center of the filter papers. The ring is filled with Putty, a 25.4 mm square piece of aluminum foil is placed on top of the ring and then a 300 gm. weight on top of that. This filled ring is allowed to stand for 72 hr at 23±2° C., after which the putty and brass ring are removed with a spatula. The top filter paper is held up to a light with a glass plate under it. The maximum and minimum diameters of the stain are marked with a sharp pencil and measured. Also, all ten individual papers are visually examined for evidence of staining by holding them up to a light. A plumber's putty is regarded as “stainfree” in accordance with this invention if two or less papers show any evidence of staining.

Meanwhile, elasticity is determined by the standard of Paragraph 3.3.2 of Int. Fed. Spec. TT-P-001536(GSA-FSS), Oct. 7, 1968, according to the protocols described in Paragraphs 4.3.2 and 4.3.3. According to the protocol of Paragraph 4.3.2, elasticity is evaluated by exposing a rope ½ inch in diameter and 3″ long made from the plumbers putty to be tested to a temperature of 32° F. for 1 hour and then quickly bending the rope over a mandrel 1 inch in diameter through an arc of 180°. If the rope can be bent in this way without cracking or breaking, the plumber's putty is regarded as passing the protocol of Paragraph 4.3.2.

In accordance with the protocol of Paragraph 4.3.3, test pieces are exposed to the atmosphere in a well ventilated room for 1 hour, followed by heating the test pieces at 180° F. for 5 minutes, followed by exposing the heated test pieces to atmosphere in the well ventilated room for an additional hour. If the test pieces show no decrease in plasticity, smoothness and homogeneity, the plumber's putty is regarded as passing the protocol of Paragraph 4.3.3. A plumber's putty which passes the protocols of both Paragraphs 4.3.2 and 4.3.3 is regarded as being elastic in accordance with this invention.

The slumping (shape retention) characteristics of a plumber's putty can be determined by heating a one inch diameter ball of the putty for 4 hours at 130° F. (˜54° C.). If the putty ball retains its shape after being heated in this way, it is regarded as being slumpfree in the context of this invention.

Plumber's putties are typically used by applying the putty to a plumbing fixture and then pushing/forcing it into place such as under the rim or edge of a sink, for example. The “feel” of a plumber's putty is the property which indicates how easily this can be done. Although “feel” is subjective, a quantitative approximation of “feel” can be determined by a compression test which measures how much force/effort is needed to push the putty into place. In accordance with this invention, “feel” is determined by placing a quantity of the plumber's putty between two plates and then forcing the plates together at a rate of 0.5 inches/min for a distance of 0.5 inches. The force needed to accomplish this compression is measured and is taken as the “feel” of the plumber's putty. The “feel” of preferred plumber's putties made in accordance is desirably about 10-50 pounds (44-222 N), more desirably 15-45 pounds (68-200 N), or even 18-30 pounds (80-133 N).

The hardness of a plumber's putty can be determined by a penetration test which measures how deep a needle of a particular size penetrates a quantity of the plumber's putty in a particular period of time under the influence of gravity. In accordance with this invention, plumber's putty samples maintained at room temperature (68-74° F.) are tested for penetration after 5 seconds using a Koehler Instruments Co. penetrometer equipped with a Humboldt Mfg. Co. H-1310 needle. The measurement is taken five times for each sample, and the average value of these measurements is taken as the penetration value. The penetration value of preferred plumber's putties made in accordance with this invention is desirably about 50-200 mm (millimeters), more desirably 60-170 mm, or even 75-140 mm.

### WORKING EXAMPLES

In order to more thoroughly describe this invention, the following working examples are provided.

### Example 1

A stain-free plumber's putty having the formulation set forth in the following Table 1 was made by heating a mixture of the ingredients forming the organic binder of the plumber's putty at a temperature of 195° F. for approximately 15 minutes until a homogenous mixture was obtained. Thereafter, the inorganic filler ingredients were added and mixing continued for an additional 30 minutes until the organic binder and inorganic filler were homogeneously mixed.

TABLE 1
Formulation of Stainfree Plumber's Putty of Example 1

| Ingredient | Amount, wt. % |
|---|---|
| Paraplex G-40 Adipate Polyester | 17 |
| low density polyethylene wax | 6 |
| propylene glycol | 4.5 |
| Claytone 40 montmorillonite clay | 2 |
| calcium carbonate | 70.5 |
| Total | 100.00 |

When tested according to ASTM-D-2203—Staining of Oil and Resin-Base Caulking Compounds, the plumber's putty obtained was found to be stain-free. In addition, when tested according to Int. Fed. Spec. TT-P-001536(GSA-FSS) Oct. 7, 1968, this plumber's putty was found to pass the elasticity tests of Paragraph 4.3.2 and 4.3.3 and the stain test of ASTM-D-2203—Staining of Oil and Resin-Base Caulking Compounds. In addition, the “feel” of the plumber's putty when tested according to the compression analytical test described above was 19 pounds, while the hardness of the this plumber's putty when tested according to the penetration analytical test described above was 99 mm. Finally, this plumber's putty was found to exhibit no slump when tested according to the slumping analytical test described above.

### Example 2 and Comparative Examples A-H

Example 1 was repeated using a variety of different formulations, and the plumber's putties obtained were tested for slump, feel and hardness. These formulations and the results obtained are set forth in the following Table 2:

TABLE 2
Example 2 and Comparative Examples A-H
Formulation and Results

| | Ingredient, wt, % | | | | | | | |
|---|---|---|---|---|---|---|---|---|
| | G- | | prop | Clay | | | Compression | Penetration |
| Example | 40 | LDPE | glycol | 40 | CaCO₃ | Slump | (Feel) | (Hardness) |
| 2 | 17 | 6 | 4.0 | 2 | 71.0 | No | 25 | 84 |
| | | | | | | Slump | | |
| A | 0 | 40 | 0 | 2.5 | 57.5 | No | 65 | 54 |
| | | | | | | Slump | | |
| B | 30 | 0 | 0 | 0 | 70 | Slumps | 7 | 134 |
| C | 40 | 0 | 0 | 0 | 60 | Slumps | 0 | 269 |
| D | 35 | 0 | 0 | 3 | 62 | Slumps | 5 | 173 |
| E | 0 | 23 | 8 | 2 | 67 | No | 67 | 48 |
| | | | | | | Slump | | |
| F | 3 | 23 | 5 | 2 | 67 | No | 71 | 52 |
| | | | | | | Slump | | |

By comparing Example 2 in Table 2 with Comparative Examples A-F, it can be seen that a stainfree plumber's putty whose organic binder is based on the combination of a liquid polyester (adipate polyester G-40) and a low density wax component (LDPE) can take up and hold a greater amount of inorganic filler than otherwise identical plumber's putties made with even greater amounts of these organic binder ingredients when used individually. In particular, Table 2 shows that the total amount of organic binder used in the inventive stainfree plumber's putty of Example 2, 27 wt. %, was less than the total amount of organic binder used in Comparative Examples A-F (40%, 30%, 40%, 35%, 31% and 31%, respectively). Nonetheless, Table 2 also shows that notwithstanding this lower concentration of organic binder, the inventive plumber's putty of Example 2 exhibited the desired degree of pliability and flexibility (i.e., feel and hardness) without slump in contrast to the plumber's putties of Comparative Examples A-F, which either slumped or exhibited unacceptably high hardness.

### Example 2 and Comparative Examples G-J

Additional comparative plumber's putties G-T were formulated and tested for slump and hardness. These formulations and the results obtained are set forth in the following Table 3, Table 3 also including the plumber's putties of the above Example 2 and Comparative Examples A, B, C and D for comparative purposes:

TABLE 3
Example 2 and Comparative Examples A-D and G-J
Formulation and Results

| | Ingredient, wt, % | | | | | |
|---|---|---|---|---|---|---|
| Example | G-40 | LDPE | prop glycol | Clay 40 | CaCO₃ | Results |
| 2 | 17.0 | 6.0 | 4.0 | 2.0 | 71.0 | Good |
| A | 0 | 40.0 | 0 | 2.5 | 57.5 | Too Hard |
| B | 30.0 | 0 | 0 | 0 | 70.0 | Slumps |
| C | 40.0 | 0 | 0 | 0 | 60.0 | Slumps |
| D | 35.0 | 0 | 0 | 3.0 | 62.0 | Slumps |
| G | 0 | 40.0 | 0 | 0 | 60.0 | Slumps |
| H | 0 | 40.0 | 0 | 5.0 | 55.0 | Too Hard |
| I | 20.0 | 0 | 0 | 0 | 80.0 | Slumps |
| J | 30.0 | 0 | 0 | 2.5 | 67.5 | Slumps |

Table 3 further shows the advantages of using the combination of a liquid polyester and a low density wax component (LDPE) in connection with making a stainfree plumber's putty having the physical properties of conventional plumber's putties. In particular, Table 3 shows that the combination of a liquid polyester and a low density wax not only can take up and hold a greater amount of inorganic filler than these organic binders when used individually, but also that this combination provides plumber's putties with the desired shape retention (absence of slump) and pliability (absence of excessive hardness) properties even though these organic binders when used individually cannot.

Although only a few embodiments of this invention have been described above, it should be appreciated that many modifications can be made without departing from the spirit and scope of the invention. All such modifications are intended to be include within the scope of this invention, which is to be limited only by the following claims:

1. An elastic, stainfree, slumpfree plumber's putty comprising at least one inorganic particulate filler and an organic binder comprising a liquid polyester and a low density wax.

2. The plumber's putty of claim 1, wherein the plumber's putty further contains a non-migrating polyol.

3. The plumber's putty of claim 1, wherein the non-migrating polyol is ethylene glycol, propylene glycol, 1-4 butanediol, hexylene glycol or mixtures thereof.

4. The plumber's putty of claim 3, wherein the liquid polyester has an average molecular weight of 3000-8000 at 80° C.

5. The plumber's putty of claim 4, wherein the liquid polyester is the reaction product of a saturated dibasic acid having the general formula, HOOC(CH₂)ₙCOOH, where n=2-20.

6. The plumber's putty of claim 5, wherein the low density wax is a synthetic wax made by polymerizing or copolymerizing at least one of ethylene, propylene, n-butylene and iso-butylene to form a polymerized product having a density of about 0.5 to 1.2 glee.

7. The plumber's putty of claim 6, wherein the particulate filler comprises a mixture of a calcium carbonate and clay.

8. The plumber's putty of claim 7, wherein the particulate filler comprises a mixture of calcium carbonate and a montmorillonite clay in which the relative proportion of montmorillonite clay to calcium carbonate to is about 1:60 to 1:20.

9. The plumber's putty of claim 1, wherein the liquid polyester is the reaction product of a saturated dibasic acid having the general formula, HOOC(CH₂)ₙCOOH, where n=2-20.

10. The plumber's putty of claim 9, wherein the liquid polyester has an average molecular weight of 3000-8000 at 80° C.

11. The plumber's putty of claim 10, wherein the low density wax is a synthetic wax made by polymerizing or copolymerizing at least one of ethylene, propylene, n-butylene and iso-butylene to form a polymerized product having a density of about 0.5 to 1.2 g/cc.

12. The plumber's putty of claim 11, wherein the particulate filler comprises a mixture of a calcium carbonate and clay.

13. The plumber's putty of claim 12, wherein the particulate filler comprises a mixture of calcium carbonate and a montmorillonite clay in which the relative proportion of montmorillonite clay to calcium carbonate to is about 1:60 to 1:20.

14. The plumber's putty of claim 1, wherein the plumber's putty contains >0 to about 10 wt. % montmorillonite clay, >0 to about 90 wt. % calcium carbonate, about 5 to 40 wt. % liquid polyester adipate, about 1 to 35 wt. % low density polyethylene, and >0 to about 15 wt. % propylene glycol.

15. The plumber's putty of claim 14, wherein the plumber's putty contains about 0.5 to 5 wt. % montmorillonite clay, about 50 to 85 wt. % calcium carbonate, about 10 to 25 wt. % liquid polyester adipate, about 3 to 10 wt. % low density polyethylene, and about 2 to 7 wt. % propylene glycol.

16. The plumber's putty of claim 15, wherein the plumber's putty contains about 1 to 3 wt. % montmorillonite clay, about 60 to 80 wt. % calcium carbonate, about 15 to 19 wt. % liquid polyester adipate, about 4 to 8 wt. % low density polyethylene, and about 3 to 6 wt. % propylene glycol.
